(19) United States
(12) Patent Application Publication
(10) Pub. No.: US 2017/0164212 A1
(43) Pub. Date: Jun. 8, 2017

(54) NETWORK SLICE MANAGEMENT

(71) Applicant: Telefonaktiebolaget L M Ericsson (publ), Stockholm (SE)

(72) Inventors: Miljenko OPSENICA, Espoo (FI); Jari ARKKO, Kauniainen (FI); Heidi-Maria BACK, Helsinki (FI); Tomas MECKLIN, Kyrkslätt (FI); Göran RUNE, Linköping (FI); Mohit SETHI, Espoo (FI); Le WANG, Helsinki (FI)

(73) Assignee: Telefonaktiebolaget L M Ericsson (publ), Stockholm (SE)

(21) Appl. No.: 14/787,900

(22) PCT Filed: Sep. 29, 2015
(86) PCT No.: PCT/SE2015/051029

§ 371 Date: Oct. 29, 2015

(51) Int. Cl. H04W 24/02; H04L 12/24; H04W 84/00; G06F 17/30

(52) U.S. Cl. CPC H04W 24/02; G06F 17/3002; H04L 41/0246; G06F 17/30091; H04L 41/042; H04W 84/00

(57) ABSTRACT

A network slice selection involves authenticating, by an identity manager (1) of a network operator (4), a user device (8) and/or user based on a network attachment request originating from the user device (8) to correlate the user device (8) and/or user to a network slice of multiple network slices (3) provided by the network operator (4). The identity manager (1) authorizes access to a network slice (3) of the network slice type based on credentials of the user device (8) and/or user. The identity manager (1) provides information of an entry point to an application provided by the network slice (3) for transmission to the user device (8).

### TECHNICAL FIELD

The present embodiments generally relate to network slice management, and in particular to selection of network slices for user devices and/or users.

### BACKGROUND

A network slice, sometimes denoted network instance in the art, is a logical instantiation of a network, where Virtualized Network Functions (VNFs) can be delivered and deployed as pre-integrated systems. From the management perspective, network slicing splits the network management domain into sub-domains. Each network slice has its own management domain, allowing deployment, upgrade, and any other network operation to be independent of other network slices. More importantly, network slicing enables Mobile Virtual Network Operators (MVNOs) and service providers to have their own network slices, which can be crafted to meet the policy, expected behavior and requirements of different type of data or communication services. Network slicing allows a service provider to be focused on the management of network solutions driven by business requirements with self-contained and automated network architecture.

Thus, a network operator would have a physical network infrastructure, which could support many separate virtualized networks, i.e. network slices. Each such network slice may then have unique characteristics for meeting specific requirements of the use case it serves. Network slicing thereby allows, for instance, separation of data traffic for different types of services, business segment separation, maintaining integrity between different services, performance optimization for different services, usage of different security levels and performing software upgrades in separate network slices.

For example, a network slice could include Public Data Network (PDN) Gateway (GW) (PGW), Serving GW (SGW), Mobile Management Entities (MMEs) and Policy Control Resource Functions (PCRFs) as Evolved Packet Core (EPC) for typical mobile broadband usage. Another network slice has combined PGW/SGW and an MME, but no PCRF, using only static policies but no per user dynamic policies. The MME could be simplified for stationary Machine Type Communication (MTC) and Machine-to-Machine (M2M) services. There could be also network slices dedicated to users having non-Subscriber Identity Module (non-SIM) identities and various specific authentication mechanisms, e.g. Facebook or Google slices. In such a case, the network slice might contain only a limited subset of EPC functions. In general, a network slice has to be able to identify and authenticate all attached user devices.

In the current mobile networks, a user device is attached to a network provider independently on traffic type or subscribed services. The same is valid in the roaming scenario when only preferred visited networks are used. From the other end, the network slicing concept can result in a high number of network slices and Virtual Network Operators (VNOs) sharing the same network infrastructure. Different network slices can be related to numerous user device identity types and numerous authentication mechanisms. User device identity could, for instance, be SIM identity, bank account identity, Internet of Things (IoT) sensor identity, etc. Therefore, selecting a network slice is becoming an important new function addressing new requirements. Network slice discovery and selection should be dynamic, flexible and extendable in comparison with an existing networks, where selection is fixed, restrictive and controlled by a single network operator.

There is, thus, a need for an efficient selection of network slices for users and/or user devices.

### SUMMARY

It is a general objective to provide an efficient selection of network slices for users and/or user devices.

This and other objectives are met by embodiments as defined herein.

An aspect of the embodiments relates to a network slice selection method. The method comprises authenticating, by an identity manager of a network operator providing multiple network slices having a respective network slice type, a user device and/or a user of the user device based on a network attachment request originating from the user device to correlate the user device and/or the user to a network slice type. The method also comprises authorizing, by the identity manager, access to a network slice of the network slice among the multiple network slices based on credentials of the user device and/or the user. The method further comprises providing, by the identity manager and for transmission to the user device, information of an entry point to an application provided by the network slice.

Another aspect of the embodiments relates to an identity manager. The identity manager is configured to authenticate a user device and/or a user of the user device based on a network attachment request originating from the user device to correlate the user device and/or the user to a network slice type of a network operator providing multiple network slices having a respective network slice type. The identity manager is also configured to authorize access to a network slice of the network slice type among the multiple network slices based on credentials of the user device and/or the user. The identity manager is further configured to provide, for transmission to the user device, information of an entry point to an application provided by the network slice.

A related aspect of the embodiments defines an identity manager. The identity manager comprises an authentication unit for authenticating a user device and/or a user of the user device based on a network attachment request originating from the user device to correlate the user device and/or the user to a network slice type of a network operator providing multiple network slices having a respective network slice type. The identity manager also comprises an authorization unit for authorizing access to a network slice of the network slice type among the multiple network slices based on credentials of the user device and/or the user. The identity manager further comprises a providing unit for providing, for transmission to the user device, information of an entry point to an application provided by the network slice.

A further aspect of the embodiments relates to a computer program comprising instructions, which when executed by at least one processor, cause the at least one processor to authenticate a user device and/or a user of the user device to correlate the user device and/or the user to a network slice type of a network operator providing multiple network slices having a respective network slice type. The at least one processor is also caused to authorize access to a network slice of the network slice type among the multiple network slices based on credentials of the user device and/or the user. The at least one processor is further caused to provide, for transmission to the user device, information of an entry point to an application provided by the network slice.

A related aspect of the embodiments defines a carrier comprising a computer program as defined above. The carrier is one of an electronic signal, an optical signal, an electromagnetic signal, a magnetic signal, an electric signal, a radio signal, a microwave signal, or a computer-readable storage medium.

Another related aspect of the embodiments defines a computer-program product comprising a computer-readable medium having stored thereon a computer program as defined above.

The present embodiments provide support for attachment and selection of network slices for a variety of user devices. The present embodiments furthermore allow reduction of the total number of advertised network slices per network operator to a low number, or even a single network slice comprising an identity manager that may handle network slice attachment and selection for all network slices of the network operator and for all types of user devices.

### BRIEF DESCRIPTION OF THE DRAWINGS

The embodiments, together with further objects and advantages thereof, may best be understood by making reference to the following description taken together with the accompanying drawings, in which:

FIG. 1 is a flow chart illustrating a network slice selection method according to an embodiment;

FIG. 2 is a flow chart illustrating an additional, optional step of the method shown in FIG. 1 according to an embodiment;

FIG. 3 is a flow chart illustrating an additional, optional step of the method shown in FIG. 1 according to another embodiment;

FIG. 4 is a flow chart illustrating additional, optional steps of the method shown in FIG. 1 according to an embodiment;

FIG. 5 is a flow chart illustrating an additional, optional step of the method shown in FIG. 4 according to an embodiment;

FIG. 6 is a flow chart illustrating an additional, optional step of the method shown in FIG. 1 according to a further embodiment;

FIG. 7 is a flow chart illustrating an additional, optional step of the method shown in FIG. 1 according to yet another embodiment;

FIG. 8 is a flow chart illustrating an embodiment of the authorization step shown in FIG. 1;

FIGS. 9A-9B schematically illustrate signaling between entities involved in a network slice selection procedure according to an embodiment;

FIGS. 10A-10D illustrate deployment scenarios of identity managers according to various embodiments;

FIG. 11 is a signal diagram illustrating signaling involved in a network slice selection method according to an embodiment;

FIG. 12 is a signal diagram illustrating signaling involved in a network slice selection method according to another embodiment;

FIG. 13 is a signal diagram illustrating signaling involved in a network slice selection method according to a further embodiment;

FIG. 14 is a signal diagram illustrating signaling involved in user or user device authentication according to an embodiment;

FIG. 15 is a signal diagram illustrating signaling involved in user or user device authentication according to another embodiment;

FIG. 16 is a schematic block diagram of an identity manager according to an embodiment;

FIG. 17 is a schematic block diagram of an identity manager according to another embodiment;

FIG. 18 is a schematic block diagram of an identity manager according to a further embodiment;

FIG. 19 schematically illustrates a computer program based implementation of an identity manager according to an embodiment;

FIG. 20 is a schematic block diagram of an identity manager according to yet another embodiment;

FIG. 21 schematically illustrate a distributed implementation of the identity manager among multiple network devices; and

FIG. 22 is a schematic illustration of an example of a wireless communication system with one or more cloud-based network devices according to an embodiment.

### DETAILED DESCRIPTION

Throughout the drawings, the same reference numbers are used for similar or corresponding elements.

The present embodiments generally relate to network slice management, and in particular to selection of network slices for user devices and/or users.

Network slicing creates an efficient way to deploy and manage network services and business offering. End users can use a network slice, sometimes denoted network instance in the art, which provides services they subscribe to. In order to achieve this, proper network slice selection mechanisms should be in place to allow selection of a correct network slice for users.

Unlike their 2G/3G/4G predecessors, 5G will bring an ability of operators and their equipment suppliers to seamlessly integrate all types of access technologies, i.e. fixed, mobile, WiFi, short-range radios, etc., to serve a number of use cases. The prior art solution of selecting a network slice for a user presumes that each user device has a subscribed identity module (SIM) card. This means that the information needed to select a network slice resides or is relied on the SIM card.

However, 5G requires a network slice selection mechanism that supports both SIM-based devices and user devices without any SIM cards, such as a sensor that does not have SIM card due to its limited size or cost. Further issues with regard to implementing an efficient network slice selection mechanism include deployment scalability and backwards compatibility. In order to support existing user devices, e.g. legacy mobile phones, existing sensors and so on, it is generally better to provide a network slice selection mechanism allowing user devices to connect to network slices without having to upgrade the user devices.

Network slices may be created upon business demands. This means that one service provider or mobile virtual network operator (MVNO) could offer multiple network slices for its own business customers for various use cases. Furthermore, it would be possible to increase or decrease the number of network slices upon changing business needs. Accordingly, the number of network slices may in the near future be too large for current mobile networks to handle with the prior art selection mechanisms. Thus, proper a network slice selection mechanism needs to cope with the volume and dynamics of network slices.

The present embodiments introduce an identity manager (IDM) that acts as an authentication and authorization entity, and also serves as a network slice attachment point when a user device sends attachment request via a network node, such as evolved NodeB (eNodeB or simply eNB). User and/or user device identification in the IDM triggers selection of a network slice type capable of handling the identified user and/or user device. Following authentication in the IDM, a final network slice selection is made to determine whether the user and/or user device is authorized to connect to that network slice.

The proposed technology is very flexible and can therefore be applied to achieve network slice selection for virtual network operators (VNOs) providing multiple network slices even though the actual network infrastructure may be owned and provided by another entity, the network owner. Such a VNO is sometimes denoted MVNO in the art in particular if the relevant network infrastructure provides mobile, radio-based communication services. The proposed technology is, however, not limited to network slice selection for VNOs and MVNOs but can also be applied to non-virtualized operators. In such a case, the network operator providing the multiple network slices is typically also the network owner, i.e. owns the network infrastructure or at least a portion thereof.

The network infrastructure includes network nodes. As used herein, the non-limiting term “network node” may refer to base stations, access points, network control nodes, such as network controllers, radio network controllers, base station controllers, access controllers, and the like. In particular, the term “base station” may encompass different types of radio base stations including standardized base station functions, such as NodeBs, or eNBs, and also macro/micro/pico radio base stations, home base stations, also known as femto base stations, relay nodes, repeaters, radio access points, Base Transceiver Stations (BTSs), and even radio control nodes controlling one or more Remote Radio Units (RRUs), or the like.

As used herein, a user device, also referred to as user equipment (UE), may refer to a mobile phone, a cellular phone, a Personal Digital Assistant (PDA) equipped with radio communication capabilities, a smart phone, a laptop or Personal Computer (PC) equipped with an internal or external mobile broadband modem, a tablet with radio communication capabilities, a target device, a device to device UE, a machine type UE or UE capable of machine to machine communication, Customer Premises Equipment (CPE), Laptop Embedded Equipment (LEE), Laptop Mounted Equipment (LME), USB dongle, a portable electronic radio communication device, a sensor device equipped with radio communication capabilities or the like. In particular, the term “user device” should be interpreted as a non-limiting term comprising any type of device capable of communicating with a network node in a wireless communication system and/or possibly communicating directly with another user device. In other words, a user device may be any device equipped with circuitry for wireless communication according to any relevant standard for communication.

Due to higher business demands in the network slicing architecture, the number of network slices can easily get too large for the current mobile network to handle. For instance, one network operator can have multiple network slices for different user device types, different services as well as for different operational reasons. With a large number of network slices supporting different user device types for different services, network slice selection is becoming a very difficult and segmented function.

The proposed network slice selection method uses an identity manager, also denoted Identity Management (IDM) component, to determine user device and/or user correlated network slices. The proposed technology introduces a common identity manager per network operator that can be part of each network slice, distributed among network slices or implemented in a single network slice. This results in a flexible and scalable setup where a network operator can advertise a single network slice, or a subset of the network slices, to users.

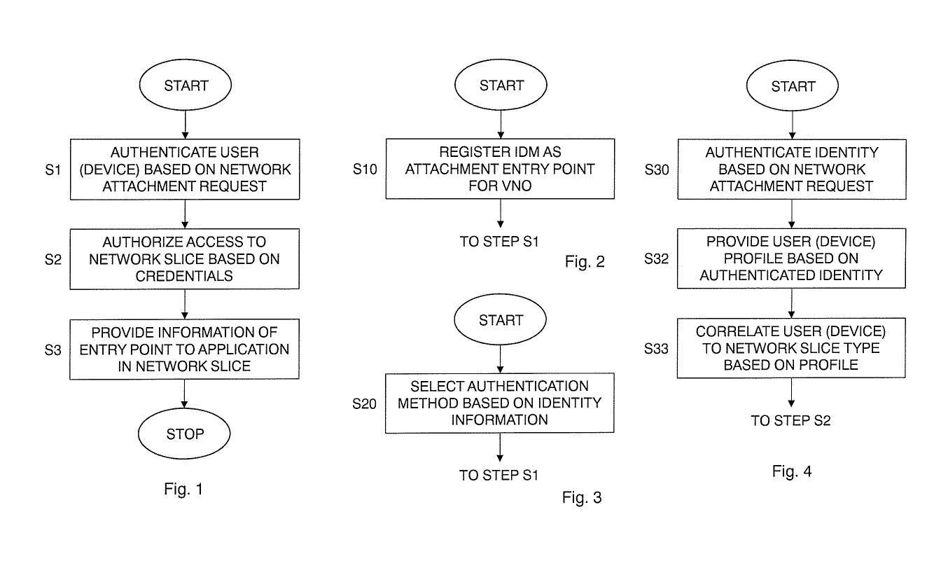

FIG. 1 is a flow chart illustrating a network slice selection method according to an embodiment. The method comprises authenticating, in step S1 and by an identity manager of a network operator providing multiple network slices having a respective network slice type, a user device and/or a user of the user device based on a network attachment request originating from the user device to correlate the user device and/or the user to a network slice type. A next step S2 comprises authorizing, by the identity manager, access to a network slice of the network slice type among the multiple network slices based on credentials of the user device and/or the user. The following step S3 comprises providing, by the identity manager and for transmission to the user device, information of an entry point to an application provided by the network slice.

The method steps of the network slice selection method are thereby preferably performed by and in an identity manager. Each network operator thereby preferably has access to at least one such identity manager, although it may be feasible for multiple network operators to have a common identity manager handling network slice selection for users accessing a network slice of either network operator.

The identity manger then manages the two main steps of the network slice selection, i.e. the user and/or user device authentication in step S1 and the user and/or user device authorization in step S2. The authentication step is performed in order to authenticate the user and/or user device transmitting a network attachment request. This authentication in turn correlates or connects the user or user device to a particular network slice type.

Each network slice has a respective network slice type. In such a case, each network slice provided by the network operator could have a unique networks slice type that is different from the network slice types of all other network slices provided by this network operator. Thus, if the network operator provides N≧2 network slices these are of N different network slice types, T₁, T₂, . . . , T_{N}. Alternatively, at least two of the network slices provided by the network operator could be of the same network slice type.

The network slice type division could be based on the services provided in or the applications provided by, i.e. running in, the network slice, such as mobile or wireless broadband (MBB) services or applications, mobile or wireless multicast services or applications, Machine Type Communication (MTC) services or applications, Machine-to-Machine (M2M) services or applications, etc.

A further alternative is to define network slice types depending on the authentication mechanism to authenticate users or user devices, such as SIM-based network slices, Facebook network slices, Google network slices, etc.

Yet another alternative to define network slice types is based on the functionality included or supported by the network slice, such as PGW, SGW, MMEs, and/or PCRFs, etc.

The second step, the authorization steps, is performed in order to verify that the user and/or user device is authorized to select a network slice of the correct or identified network slice type. This user and/or user device authorization is managed by the identity manager based on credentials of the user and/or user device. The identity manager could be the authorizing entity performing this authentication process all by itself. Alternatively, the identity manager could cooperate with and use another authorization device or logic to perform the user and/or user device authorization. In this case, the identity manager operates similar to an authorization proxy.

Once, and preferably only once, a user and/or user device has been successfully authenticated and authorized, the identity manager provides information of an entry point to an application running in or provided by the network slice of the identity network slice type. This information can then be sent to the user device in order to enable the user device to access the application and the network slice.

The authentication and authorization performed in FIG. 1 could be performed in order to authenticate and authorize the user of the user device. In such a case, the authentication and authorization steps are preferably performed based on information of the particular user, such as identity or identifier of the user, a user profile and/or subscription information of the user. Alternatively, the authentication and authorization could be performed in order to authenticate and authorize the user device that the user employs in order to attach and connect to a network slice. In such a case, the authentication and authorization steps could be performed based on information of the particular user device, such as identity or identifier of the user device, a user device profile and/or capabilities of the user device. It is, though, possible to authenticate and/or authorize both the user and the user device in the method as shown in FIG. 1.

FIG. 2 is a flow chart illustrating an additional, optional step of the method shown in FIG. 1. The method starts in step S10, which comprises registering the identity manager as an attachment entry point for the multiple network slices of the network operator at a database of registered network slices.

In this embodiment, identity managers of network operators are registered at a database as respective attachment entry points for the network slices provided by the respective network operators. This means that any attachment requests generated by user devices in connection with accessing a network slice is sent or directed to the attachment entry point registered in the database.

The database could be any database or register that houses the information of the identity managers, i.e. information allowing transmission of network attachment requests to the identity managers. As a non-limiting but illustrative example of a particular implementation of such a database, the registration in step S10 could be made at a Domain Name System (DNS) server. The information registered in the database is thereby location information or address information of the identity manager.

In a particular embodiment, each network operator registers a single identity manager in the database. In such a case, all attachment requests from users or user devices to the multiple network slices provided by a network operator is directed or sent to the single identity manager. It is, however, possible to register more than one identity manager for a given network operator in the database, in particular for a network operator handling a large amount of network attachment requests and where the management of such network attachment requests need to be distributed between multiple identity managers of the network operator. However, generally the number of identity managers and attachment entry points registered by a network operator is preferably lower than the total number of network slices that the network operator provides.

The registered information in the database is preferably provided to network nodes, such as eNBs, such as upon request from such network nodes. The network nodes may then announce or advertise the available network slices to user devices by transmitting the information of the registered attachment entry point to the user devices. This enables a user device to send the network attachment request to the correct entity, i.e. the identity manager, of the relevant network operator. In an alternative embodiment, the network node announces or advertises the network slices and/or operator, such as by announcing or advertising information of the registered network slice(s) and/or the network operator. In such a case, the user device transmits a network attachment request comprising information of a desired and selected network operator and/or network slice to the network node. The network node can then investigate the list or information obtained from the database to match the information of the selected network operator and/or network slice with the attachment entry point registered for that particular network operator. The network node then forwards and directs the network attachment request to this attachment entry point, i.e. identity manager, of the relevant network operator.

FIG. 3 is a flow chart of another optional step of the method as shown in FIG. 1. In this embodiment, a step S20 comprises selecting, by the identity manager, an authentication method among multiple authentication methods based on identity information retrieved from the network attachment request. The method then continues to step S1 in FIG. 1, which comprises, in this embodiment, authenticating, by the identity manager, the user device and/or the user based on the network attachment request and according to the selected authentication method.

Thus, the identity information included in the network attachment request allows the identity manager to identify and determine which particular authentication method that should be used for the given user or user device. Different such authentication methods may use different types or formats of identity information.

Non-limiting but illustrative examples of such different authentication methods include Authentication, Authorization and Accounting (AAA) protocols. In such a case, the identity information could include username and password using an Extensible Authentication Protocol-Pre-Shared Key (EAP-PSK), certificates using EAP-Transport Layer Security (EAP-TLS), SIM credentials using EAP-SIM, EAP-Authentication and Key Agreement (EAP-AKA) or EAP-AKA Prime (EAP-AKA′).

Further EAP-based authentication solutions include EAP-MDS, EAP-Protected One-Time Password (EAP-POTP), EAP-Password (EAP-PWD), EAP-Tunneled Transport Layer Security (EAP-TTLS), EAP-Internet Key Exchange version 2 (EAP-IKEv2), EAP-Flexible Authentication via Secure Tunneling (EAP-FAST), EAP-Generic Token Card (EAP-GTC), EAP-Encrypted Key Exchange (EAP-EKE).

Other examples of authentication methods include OpenID-based authentication and MME authentication. Also authentication based on Facebook or Google identities are possible as illustrative examples.

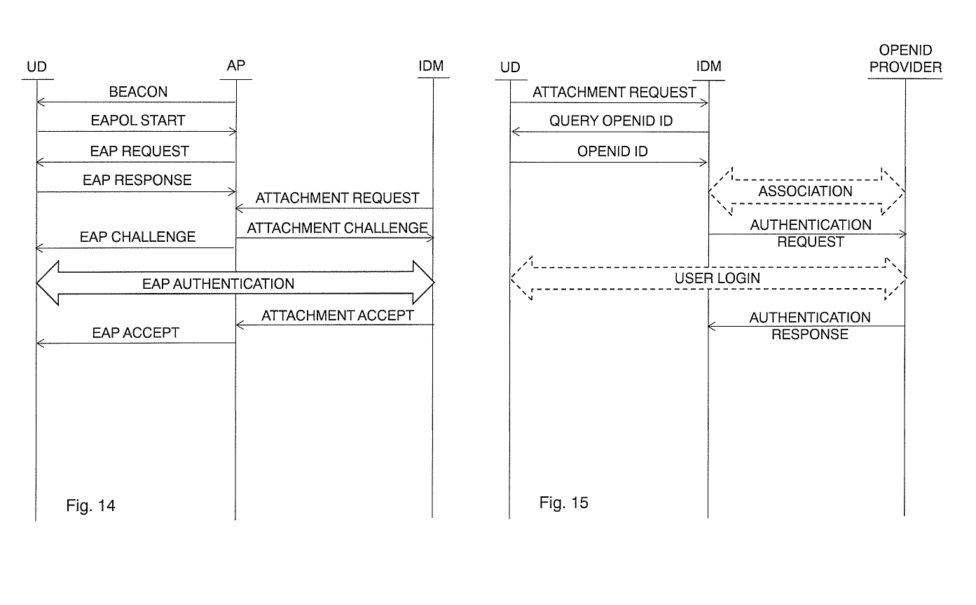

Signaling involved in various authentication methods will be further described herein with reference to FIGS. 14 and 15.

Hence, in this embodiment the identity manager supports various authentication methods and can thereby handle network attachment requests from user devices having different types or formats of identity information.

FIG. 4 is a flow chart illustrating an implementation example of the authenticating step S1 in FIG. 1. The method starts in step S30, which comprises authenticating, by the identity manager, an identity of the user device and/or the user based on the network attachment request. A next step S32 comprises providing, by the identity manager, a user device profile of the user device and/or a user profile of the user based on the authenticated identity of the user device and/or the user. The next step S33 comprises correlating, by the identity manager, the user device and/or the user to the network slice type by matching capabilities of the user device with respective requirements for the network slice types based on the user device profile and/or matching a subscription of the user with the network slice types based on the user profile.

In this implementation example, the identity manager authenticates an identity of the user device and/or the user based on the network attachment request and preferably based on the above described identity information included in the network attachment request. The identity manager further provides the user device profile of the user device with authenticated identity and/or a user profile of the user with authenticated identity. This provision could be performed according to various embodiments. In an embodiment, the identity manager has access to user device profiles and/or user profiles of user devices and/or users having a subscription with the network operator. The identity manager then simply retrieves the relevant user device profile and/or user profile based on the authenticated identity of the user device and/or user. In another embodiment, the identity manager requests the user device profile and/or user profile from another device or server, such as a Home Subscriber Server (HSS) or a User Profile Server Function (UPSF), using the authenticated identity of the user device and/or user. In a further embodiment, the user device profile and/or user profile is included in the network attachment request originating from the user device. The identity manager can then provide the user device profile and/or user profile by retrieving it from the network attachment request.

A user device profile lists capabilities of the user device. These capabilities are then matched with the respective requirements for the network slice types to see which network slice type or types that the user device can access. Thus, the user device is preferably only allowed to access a network slice type if the capabilities of the user device matches or exceeds the requirements for that network slice type.

Non-limiting but illustrative examples of such capabilities include capacity, latency, bandwidth, distribution, mobility, real-time requirements, reliability, security level, software/device version, location requirements, supported service(s), etc.

Correspondingly, a user profile comprises subscription data or information for the user. This subscription data can then be matched with a corresponding subscription or subscription data housed at the identity manager or at least accessible to the identity manager, such as from a HSS. The identity manager can then verify whether data in the user profile matches the subscription as required for accessing a network slice provided by the network operator.

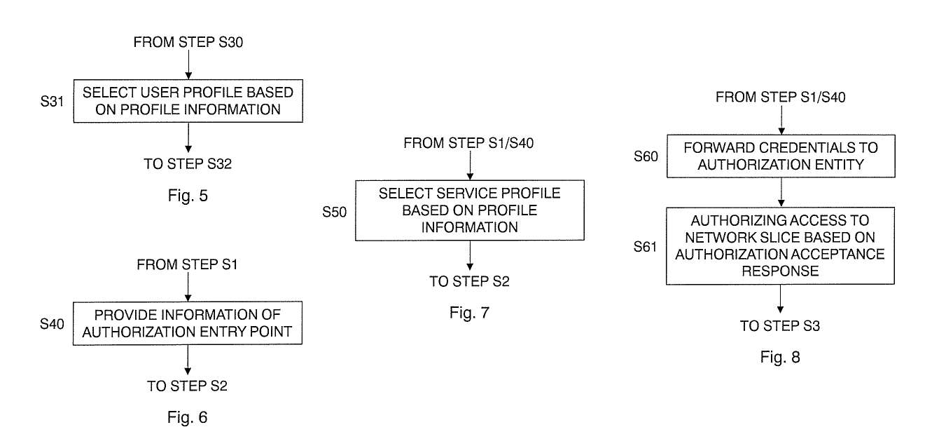

FIG. 5 is a flow chart illustrating an additional, optional step to the method shown in FIG. 4. Accordingly, the method continues from step S30 in FIG. 4. A next step S31 comprises selecting, by the identity manager, a user profile among multiple user profiles of the user based on profile information originating from the user device.

In this embodiment, the user has multiple different user profiles. The particular user profile to use in step S33 of FIG. 4 is then selected based on the profile information from the user device. In a typical embodiment, the network attachment request from the user device comprises this profile information. Alternatively, the user device could send the profile information in a message separate from the network attachment request, such as in response to an explicit request for the profile information from the identity manager. The method then continues to step S32 in FIG. 4.

Examples of different user profiles include high vs. low connectivity speed profiles, private user profile vs. work-related user profile, etc.

This means that in some cases the user might have several user profiles for a same network slice type and the network operator may have separate network slices for each user profile type. In those cases, the user device optionally sends profile information, such as in the form of a set of wished capabilities and/or service profile type, in, for instance, the network attachment request. The identity manager can then use that input, i.e. profile information, in the network slice selection.

FIG. 6 is a flow chart illustrating an additional, optional step of the method shown in FIG. 1. The method continues from step S1 in FIG. 1 to step S40. This step S40 comprises providing, by the identity manager, information of an authorization entry point at the identity manager for transmission to the user device following authentication of the user device and/or user.

Thus, in this embodiment, once the user device and/or user has been authenticated, the authorization step starts by providing and preferably transmitting, to the user device, information of an authorization entry point at the identity manager. This information in turns enables the user device to transmit an authorization request with the user device and/or user credentials to the identity manger to be used during the authorization.

The method then continues to step S2 of FIG. 1. In an embodiment, this step S2 comprises authorizing, by the identity manager, access to the network slice based on the credentials received by the identity manager at the authorization entry point and originating from the user device.

This embodiment thereby enables the identity manager to distribute the processing of network attachment requests and authorization requests to different entry points or addresses of the identity manager.

In an alternative embodiment, step S40 is omitted. In this case, the same entry point at the identity manager to which the user device transmitted the network attachment request could be used when transmitting the authorization request. In a further variant, the credentials of the user device and/or user are included in the original network attachment request. In such an embodiment, step S2 of FIG. 1 preferably comprises authorizing, by the identity manager, access to the network slice based on the credentials retrieved by the identity manager from the network attachment request.

This means that the user device only needs to transmit a single request in order to effectuate the authentication and authorization, i.e. no separate authorization request is needed.

FIG. 7 is a flow chart illustrating an additional, optional step of the method shown in FIG. 1. The method continues from step S1 in FIG. 1 or step S40 in FIG. 6. The next step S50 comprises selecting, by the identity manager, a service profile of the user based on profile information originating from the user device. The method then continues to step S2 in FIG. 1. In this embodiment, step S2 preferably comprises authorizing, by the identity manager, access to the network slice based on the credentials and the service profile.

In this embodiment, a service profile of the user is selected by the identity manager based on profile information originating from the user device. This profile information could, for instance, be included in an authorization request, the network attachment request or indeed in a separate message transmitted by the user device.

The service profile could, as illustrative examples, include information of device type, information of software version implemented in the user device, information of related services, information of capabilities, such as mentioned above in connection with user device profile, information of subscription type, etc.

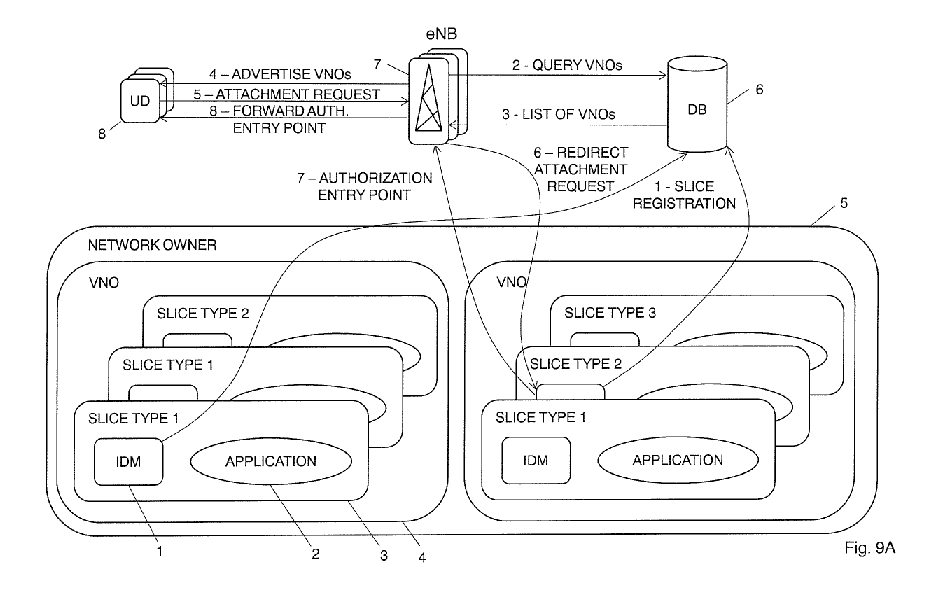

FIG. 8 is a flow chart illustrating a particular implementation example of step S2 in FIG. 1. In this implementation example the identity manager operates as an authorization proxy and thereby cooperates with an authorization entity in the authorization process. The method continues from step S1 in FIG. 1 or step S40 in FIG. 6. A next step S60 comprises forwarding, by the identity manager, the credentials to an authorization entity. In the following step S61 access to the network slice is authorized by the identity manager based on an authorization acceptance response from the authorization entity. This authorization acceptance response is generated by matching the credentials with authorization credentials stored at the authorization entity.

In this embodiment, the identity manager does not necessarily have access to authorization credentials, which in clear contrast are stored at the authorization entity. This means that the identity manager forwards the credentials received from the user device, such as in the authorization request or the network attachment request, to the authorization entity, preferably together with an identifier of the relevant user device and/or user unless the credentials comprises such an identifier. The authentication entity can then retrieve the relevant authorization credentials, preferably based on the identifier of the user device and/or user, and verify whether the received credentials match or correspond to the retrieved authorization credentials. If they match, the authorization entity compiles and returns the authorization acceptance response to the identity manager. The identity manager then concludes that the user device and/or user has been correctly authorized.

The method then continues to step S3 in FIG. 1, where the information of the entry point is provided for transmission to the user device.

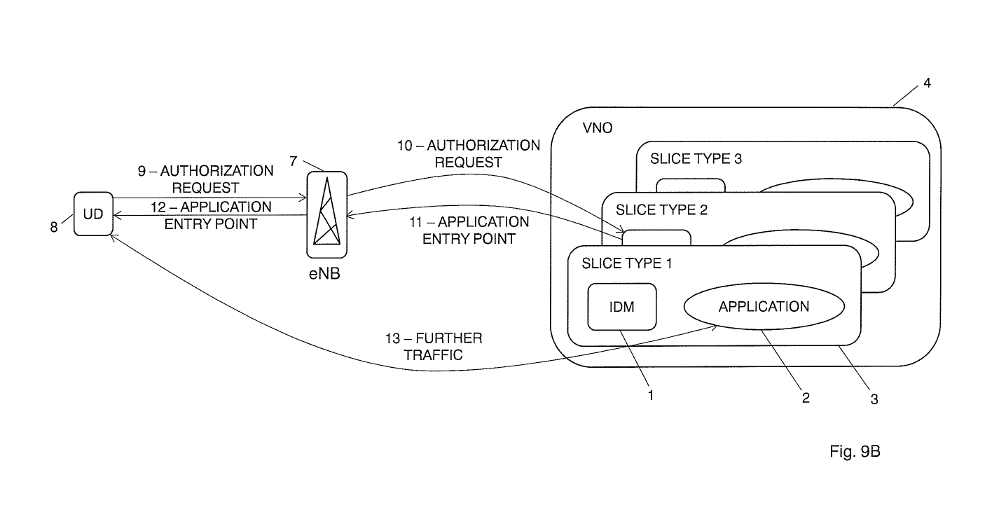

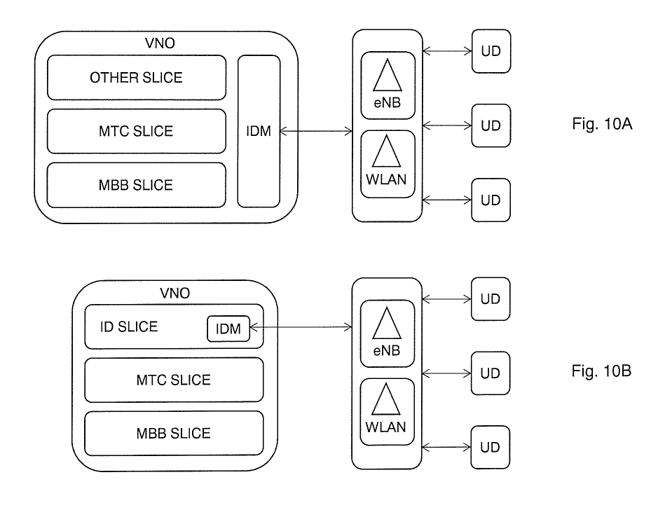

FIGS. 9A and 9B schematically illustrate signaling between entities involved in a network slice selection procedure according to an embodiment. In this embodiment, the network slice selection procedure has two main steps: network slice type identification correlated to the user device or user type, i.e. user device and/or user authentication, and network slice selection correlated to subscription, i.e. user device and/or user authorization. In this illustrative example, a number of VNOs 4, such as MVNOs, create and manage network slices 3 of various network slice types and use a commoditized network infrastructure owned by a network owner 5. The created network slices 3 are registered at a database (DB) 6 in a slice registration step 1. In this network slice registration, a VNO 4 provides information of its network identity, e.g. in the form of Public Land Mobile Network Identity (PLMN-ID) or Service Set ID (SSID) and an attachment entry point at the VNO 4. The network slice registration is preferably performed by an identity manager (IDM) 1 of the VNO 4. Please note that the attachment entry point registered in the database 6 for the VNO 1 may, but does not have to be, to the same identity manager 1 that performed the network slice registration.

A network node 7, represented by eNBs in the figure, queries the database 6 for information of the VNOs 4 available for user devices (UDs) 8 in step 2. The database 6 returns the registered information to the network node 7 in step 3. When a user device 8 tries to attach to a network, the network node 7 advertises a list of available VNOs 4 and corresponding VNO identities, or a list of available network slices 3 and corresponding VNO identities in step 4. This advertisement could be in the form of Master Information Block (MIB) and System Information Block (SIB) transmissions for mobile networks or SSID transmissions for WiFi networks. The user device 8 then selects one VNO 4 from the advertised list and transmits a network attachment request to the network node 7 in step 5. After receiving the network attachment request, the network node 7 matches the selected VNO identity with the registered entries and retrieves the attachment entry point for the selected VNO identity. The network node 7 then forwards, i.e. redirects in step 6, the network attachment request to the identity manager 1 registered as attachment entry point for the selected VNO 4 in the list at the database 6.

When the network attachment request is received by the identity manager 1, the identity manager 1 identifies the user device 8 and/or user and matches the user device and/or user identity and capability tags with the correlated network slice type, e.g. IoT device with IoT network slice type. In this case, the identity manager 1 has knowledge and capabilities to identify different UD types belonging to the same VNO 4. Please note that the network slice 4 that comprises the identity manager 1 can be of a different network slice type as compared to the network slice type selected for the user device 8, i.e. identity manager 1 present in a network slice of slice type 2, whereas the user device 1 should access an application 2 in a network slice of slice type 1.

The identity manager 1 responds back to the user device 7 with information of an authorization entry point and preferably a temporary identity of the user device 8 and/or user to be used during the network slice selection procedure. This response is sent to the network node 7 in step 7 and therefrom forwarded to the user device in step 8. In this embodiment, an authorization entry point is to an authorization function within an identity manager 1. Please note that the identity manager 1 with the authorization point may be the same or different from the identity manager that receives and handles network attachment requests, i.e. is registered in the database 6.

In a next step of the network slice selection procedure, see FIG. 9B, the user device 8 transmits an authorization request to the authorization entry point and identity manager 1 indicated in the response. The authorization request is transmitted to the network node 7 in step 9 and forwarded to the correct identity manager in step 10. The authorization request preferably comprises security information, i.e. user device and/or user credentials, and the temporary identity. The authorization request may also include the user's wished capabilities or/and preferred service profile, which can be used in the network slice selection when the user have multiple profiles for the same network slice type.

When the identity manager 1 receives the authorization request, it preferably firstly selects a correlated network slice that belongs to the same VNO 4 and meets the user device requirements. User device capability requirements and preferred profile can be read from the user's subscription data and/or from the authorization request. That input is important for the cases when user can have multiple profiles for a same network slice type. Alternatively, the identity manager 1 performs this network slice selection and user device requirement verification following reception of the attachment request.

The identity manager 1 then selects an authorization function to be used when determining whether the user device 8 and user are allowed access to the selected network slice 3. Once the user device 8 and user are authorized, the identity manager 1 provides information of an entry point to an application 2 provided by the selected network slice 3. This information of application entry point is transmitted to the network node 7 in step 11 and further to the user device in step 12. An entry point here is an application entry or access point in the selected network slice 3. All the future user device related traffic is then redirected to the selected network slice 3 using the information of received application entry point in step 13.

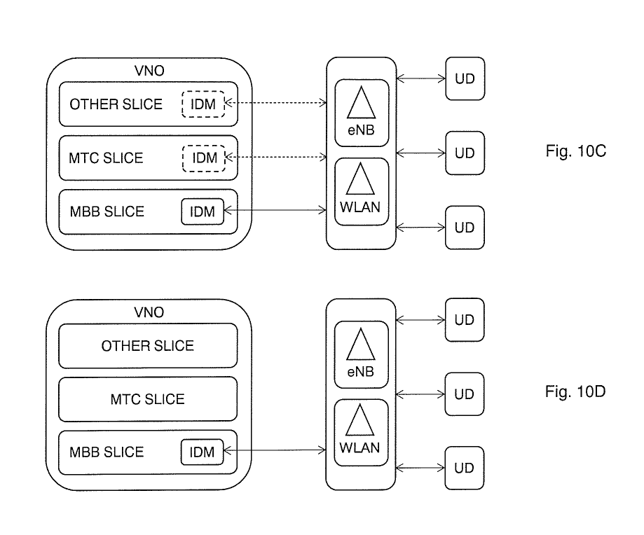

In FIGS. 9A and 9B, each network slice 3 of each VNO 4 has a respective identity manager 1. This should merely be seen as an illustrative example. FIGS. 10A to 10D illustrate various deployment scenarios of identity managers according to various embodiments.

In these figures, MTC slice denotes a network slice dedicated for machine type communication services and MBB slice denotes a network slice dedicated for mobile broadband services as illustrative examples of different types of services that can be provided in network slices.

A VNO or service provider may already have an IDM before the creation of network slices. Thus, the IDM can be deployed independently of and separate from any network slice, see FIG. 10A. In such an embodiment, the IDM preferably holds or at least has access to all authorization credentials of users and/or user devices for all network slices of the VNO. If it does not, the IDM can forward the authorization requests to an authentication entity.

Since automation is one of the main characteristics of network slice, a VNO may spin off an IDM together with other slices. Thus, the IDM can be implemented within one its own network slice, see FIG. 10B. In such an embodiment, the IDM preferably holds or at least has access to all authorization credentials of users and/or user devices for all network slices of the VNO. If it does not, the IDM can forward the authorization requests to an authentication entity.

Another deployment scenario is shown in FIG. 10C. In this case, an IDM components can be implemented within each network slice. Thus, each IDM component only holds or at least has access to the authorization credentials of users and/or user devices for its network slice. This solution provides identification isolation among the network slices.

In the deployment scenario shown in FIG. 10D, the IDM of a VNO can be within one of the network slices, for example, the first network created by this VNO. All the other network slices will consult this IDM for user authentication and authorization. If the IDM does not hold the authorization credentials, it forwards authorization requests to an authentication entity.

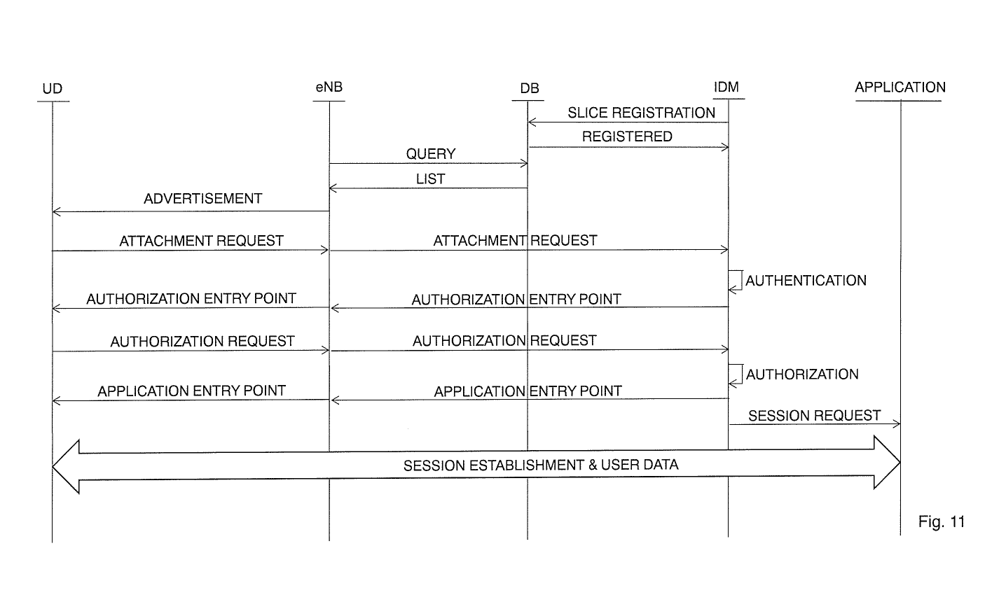

FIG. 11 is a signal diagram illustrating signaling involved in a network slice selection method according to an embodiment. The figure shows the initial slice and network operator registration at the database (DB). In this case, the database preferably confirms the slice registration with a registered confirmation. An eNB as illustrative example of a network node queries the database for information of registered network operators, available network slices and registered attachment entry points. The database returns a list with the requested information. The eNB advertise the network operators and network slices available within a network infrastructure to a user device (UD). This could be in the form of a MIB+SIB for mobile networks or SSID for WiFi networks. The user device preferably selects a network operator and returns an attachment request to the eNB comprising an identifier of the network operator, such as in the form of a PLM-ID or SSID, and an identity of the user device and/or user. The eNB uses the included network operator identifier in order to identify the attachment entry point registered for the relevant network operator. The attachment request is then forwarded to this attachment entry point, which is in the form of an identity manager (IDM) of the network operator. The identity manager authenticates the user device and/or user based on the network attachment request as described herein and correlates the user device and/or user to a network slice type provided by the network operator. Once the authentication is completed the identity manager transmits information of an authorization entry point to the user device via the eNB. The user device responds with an authorization request comprising user device and/or user credentials. In this case, the identity manager handles the authorization and performs the final network slice selection once the user device and/or user has been authorized to access the selected network slice. The identity manager returns information of an application entry point to the user device via the eNB. The identity manager preferably also transmits a session creation request to the particular application, the entry point of which was transmitted to the user device. The user device and the application can then set up and establish a communication session. All future user data is then transmitted between the user device and the application, possible via the eNB.

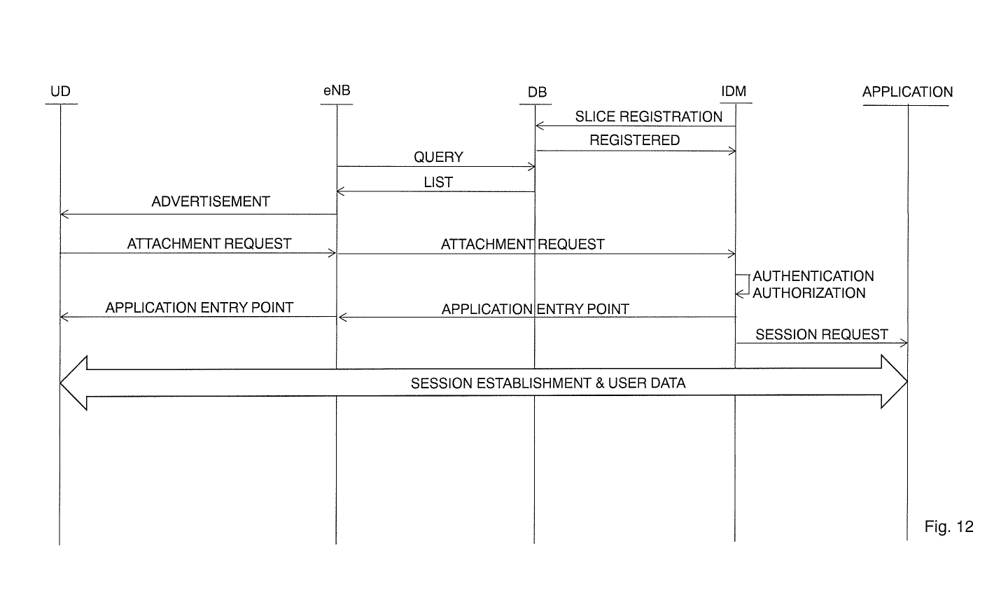

FIG. 12 is a signal diagram illustrating signaling involved in a network slice selection method according to another embodiment. The initial signaling is the same as in the embodiment shown in FIG. 11. However, in this case, the network attachment request from the user device comprises not only the identity of the network operator, such as PLMN-ID or SSID, and the identity of the user device and/or user but also the user device and/or user credentials. The identity manager can then identify the user device and/or user and correlate the user device and/or user to a network slice in the authentication step and then authorize access for the user device and/or user to the selected network slice without any additional signaling of authorization entry points and authorization requests. The following signaling is then the same as is shown in FIG. 11.

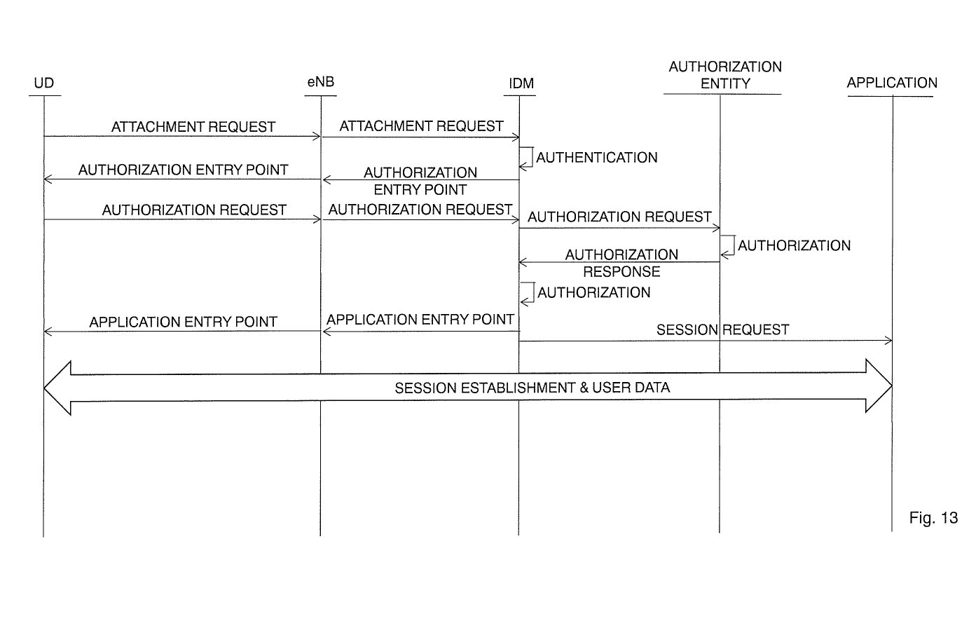

FIG. 13 is a signal diagram illustrating signaling involved in a network slice selection method according to a further embodiment. In this figure the initial signaling related to registration in the database, query the database and advertise network operators and network slices have been omitted to simplify the figure. This initial signaling has preferably previously taken place.

The authentication procedure and signaling is performed similar to the embodiment shown in FIG. 11. In this case, the identity manager, however, lacks the authorization credentials and cannot thereby by its own authorize user devices and/or users. This means that the identity manager forwards the authorization request with the user device and/or user credentials and preferably the user device and/or user identity or identifier to an authorization entity. This authorization entity has access to the authorization credentials, which are retrieved based on the user device and/or user identity or identifier. The authorization credentials are compared with the user device and/or user credentials retrieved from the authorization request. If the credentials match each other, the authorization entity generates and transmits an authorization response indicating that the user device and/or user has been correctly authorized. The identity manager thereby confirms that the user device and/or user is authorized to access the network slice. The following signaling is the same as in FIGS. 11 and 12.

The initial registration as shown in FIGS. 11 and 12 is preferably only performed once a network operator has updated its available network slices, such as added and/or removed one or more network slices. Correspondingly, the query of the database by the network node generally needs to be performed quite seldom as the data contained in the database is typically only updated once a change in network slices has been performed for a network operator. In such a case, the database could, as an alternative, push the updated data to the network node or send an indication to the network node that the data stored in the database has been updated.

FIG. 14 is a signal diagram illustrating signaling involved in a user device and/or user authentication according to an embodiment. In this embodiment, the identity manager can operate similar to a typical AAA backend server. The authentication in such a case would be based on one of the supported EAP methods between the user device as EAP peer and the identity manager as EAP authenticator.

Depending on the access network that is used by the user device, the AAA backend in the identity manager may need to support RADIUS/DIAMETER protocols as well. This would be the case when the access is based on WiFi and a 802.11 access point that tunnels the EAP message between the user device and the AAA point (AP). This is shown in FIG. 14.

The signaling involves transmission of a beacon from the AP to the user device. The user device returns an EAP over LTE (EAPoL) start. The AP sends an EAP request for the identity of the user device and/or user, whereby the user device returns an EAP response with the identity. The AP uses the identity to compile and transmit an attachment request to the identity manager using the RADIUS/DIAMETER protocol. The identity manager returns an attachment challenge using the RADIUS/DIAMETER protocol. The AP compiles, based on the attachment challenge, an EAP challenge that is sent to the user device. The authentication then continues based on the relevant EAP method, such as EAP-PSK, EAP-TLS, EAP-SIM, etc. Finally, the identity manager confirms that the attachment is accepted and transmits an attachment accept using the RADIUS/DIAMETER protocol to the AP, which forwards the attachment accept using EAP to the user device.

In some scenarios, the identity manager may not be able to authenticate the user device and/or user directly. This may be the case when the user is roaming and the authentication credentials reside in the home network. RADIUS and DIAMETER also allow the identity manager to proxy EAP messages inside RADIUS/DIAMETER to the correct authoritative server for that user. In this case, the identity manager only acts as a RADIUS/DIAMETER proxy that forwards messages based on the Network Access Identifier (NAI) of the user.

In addition, or alternatively, the identity manager may support MME authentication as is done in typical LTE networks. In such a case, when the identity manager receives a network attachment request originating from a user device, the following message exchanges may be performed during the authentication step.

An Authentication Information Request (AIR) is sent from identity manager, which hosts the MME functionality, to the HSS of the requesting user device. This AIR comprises username, i.e. identity of the user device and/or user, and visited PLMN-ID in addition to other Attribute Value Pairs (AVPs). These AVPs are used by HSS to generate authentication parameters. The HSS then responds with an Authentication Information Answer (AIA) comprising information, including an authentication token (AUTN), a random number (RAND) and an expected result (XRES), which will be used by the MME functionality to authenticate the user device and/or user. The identity manager then sends an authentication request containing the AUTN and the RAND to the user device. The user devices uses the RAND and generates an AUTN. If the AUTN received in the authentication request from the identity manager matches the one the user device generates, the user device has successfully authenticated the identity manager. The user device also generates a result (RES) with the RAND received from the identity manager and a secret key that it possess. The device transmits an authentication answer comprising the RES to the identity manager. The identity manager checks the RES received from the user device against the XRES received from the HSS. If the two matches, the identity manager has successfully authenticated the user device and/or user.

FIG. 15 illustrates another scenario, in which the identity manager supports OpenID-based authentication. In such a case, the user device transmits the network attachment request to the identity manager. This network attachment request may indicate the use of OpenID for user (device) authentication. The identity manager then sends a query for the OpenID identifier to the user device, which returns the requested OpenID. Once the identity manager has received the OpenID identifier, the identity manager queries an OpenID provider of the user with an authentication request comprising the OpenID identifier. The OpenID provider then authenticates the user and may optionally request the user to confirm the action, represented by a user login in the figure. Thereafter, if the authentication is successful, the OpenID provider sends a positive assertion to the identity manager.

The above described authentication procedures should be seen as some typical examples. However, the flexible identity manager can support other forms of authentication methods, such as Web-based authentication with digest, etc.

The identity manager of the embodiments acts as an authentication and authorization entity for network operators, including VNOs and MVNOs, and also serves as the first contact point when a user device or user sends a network attachment request. In an embodiment, the process of authentication may be based on each user or user device having a unique set of credentials. Depending on the type of authentication method, the identity manager verifies the authentication credentials to ensure that only authorized users and their user devices are allowed any further access to the network. Following authentication, a user and/or user device profile is preferably retrieved to determine whether the user and/or device has authority to connect to a network slice provided by the network operator. Following the authentication and authorization, the identity manager provides information to the user device to direct future traffic to the correct network slice.

In order to support various kinds of user devices, the authentication methods supported by the identity manager may be expandable by either software upgrade or runtime plugin installation. The authentication methods can include, for instance, AAA, OpenID authentication and authentication methods used by MME among other possible authentication methods. In some deployment scenarios, the real logic to decide whether a user device and/or user may access the network is not inside the identity component. In such a case, the identity manager can be seen as an authorization proxy to the authorization logic, which might reside in an authorization entity or indeed in a network slice.

The identity manager of the embodiments is thereby used in a network slice selection to determine user device and/or user correlated network slices.

The identity manager acts as an authentication and authorization entity, and also serves as a network slice contact point when a user device sends a network attachment request via a network node, e.g. eNB. User device and/or user identification in the identity manager triggers selection of the network slice type capable of handling the identified user device and/or user. Following authentication in the identity manager, a user device and/or user profile is retrieved to determine the final network slice selection and whether the user device and/or user is authorized to connect to that network slice.

In some cases, the user might have several user profiles for a same type of network slice and the network operator can have a separate network slice for each user profile type. In such cases, the user can optionally send a set of wished capabilities or/and service profile type in the authentication request or in the network attachment request. The identity manager can use that input in the network slice selection procedure. An alternative, is to use only the user's subscription data, which may be preferred in the backward compatible cases.

In some deployment scenarios, the authorization logic to decide whether a user device and/or user may access a network or network slice could be outside of the identity manager. In this case, the identity manager can be seen as an authorization proxy to the authorization logic.

The identity manager that belongs to the selected network operator can preferably identify, authenticate and authorize all the user device types that might want to access the network sliced provided by the network operator. The network operator can have multiple network slices and each network slice can share a common identity manager, the identity manager functionality can be distributed among the network slices or each network slice can have a respective identity manager. The network operator can, independent on implementation variant for the identity manager, register a single identity manager in a selected network slice and thereby a single attachment entry point for all network slices and all user devices independently of user device and/or user identity types and authentication method used. After authentication, the identity manager selects a matching network slice and redirects all further application traffic for that user to the selected network slice.

This solution reduces the number of advertised network slices in the network and simplifies the network slice selection. This further means that different user device types with different authentication mechanisms can get authenticated and authorized in a single network slice point, i.e. the identity manager, and still attach to the correlated and selected network slice.

The proposed solution is expandable by either software upgrade or runtime plugin installation. For instance, when a new user device type is introduced, e.g. new identity type or/and related authentication mechanism, the identity manager can be upgraded to support that user device type. Also when a new network slice is introduced, the identity manager is updated to include the network slice in the network slice selection procedure.

The embodiments thereby introduce a new component called the identity manager related to the core networks and to the concept of network slicing of future core networks. Network slicing is an essential concept in the 5G core network.

By introducing the identity manager, a network operator, such as VNO or MVNO, can authenticate and authorize a user device and/or user connecting to a network. Based on the authentication and authorization information, the user device and/or user can be directed to the right network slice. No special requirements are put on the user devices, thus legacy user devices are also supported. This means that the embodiments are backwards compatible. The proposed identity manager is compatible with different kinds of attachment or access technologies, including cellular and WiFi as illustrative examples.

The network slice selection related to the user device attachment to the network is, in an embodiment, performed through two steps. In the first authentication or identification step, the user device and/or user is identified and correlated to the network slice type offered by the network operator. In the second, authorization step, the identity manager verifies that the user device and/or user is authorized to access the selected network slice. Following the authorization, the data traffic can be directed to the selected network slice.

No special requirements are put on the user devices, thus legacy user devices are also supported. The network operator can offer multiple network slices of the same network slice type for different user profiles. In that case, user device capability requirements or/and preferred user profile can be used to select appropriate network slice. That information can be read from the user subscription data or optionally it can be sent in the network attachment request.

The proposed solution enables reduction of total number of advertised network slices per network operator even down to a single network slice by using a single identity manager entry point for all the user devices and users independently on user device and/or user identity, user device type, authentication mechanism and user services. The proposed solution is compatible with a different kind of access technologies including cellular and WiFi as illustrative examples.

Another aspect of the embodiments relates to an identity manager. The identity manager is configured to authenticate a user device and/or a user of the user device based on a network attachment request originating from the user device to correlate the user device and/or the user to a network slice type of a network operator providing multiple network slices having a respective network slice type. The identity manager is also configured to authorize access to a network slice of the network slice type among the multiple network slices based on credentials of the user device and/or the user. The identity manager is further configured to provide, for transmission to the user device, information of an entry point to an application provided by the network slice.

In an embodiment, the identity manager is configured to register the identity manager as an attachment entry point for the multiple network slices of the network operator at a database of registered network slices.

In an embodiment, the identity manager is configured to select an authentication method among multiple authentication methods based on identity information retrieved from the network attachment request. The identity manager is also configured to authenticate the user device and/or the user based on the network attachment request and according to the selected authentication method.

In an embodiment, the identity manager is configured to authenticate an identity of the user device and/or the user based on the network attachment request. The identity manager is also configured to provide a user device profile of the user device and/or a user profile of the user based on the authenticated identity of the user device and/or the user. The identity manager is further configured to correlate the user device and/or the user to the network slice type by matching capabilities of the user device with respective requirements for the network slice types based on the user device profile and/or matching a subscription of the user with the network slice types based on the user profile.

In an embodiment, the identity manager is configured to select a user profile among multiple user profiles of the user based on profile information originating from the user device.

In an embodiment, the identity manager is configured to provide information of an authorization entry point at the identity manager for transmission to the user device following authentication of the user device and/or the user.

In a particular embodiment, the identity manager is configured to authorize access to the network slice based on the credentials received by the identity manager at the authorization entry point and originating from the user device.

In an embodiment, the identity manager is configured to authorize access to the network slice based on the credentials retrieved by the identity manager from the network attachment request.

In an embodiment, the identity manager is configured to select a service profile of the user based on profile information originating from the user device. The identity manager is also configured to authorize access to the network slice based on the credentials and the service profile.

In an embodiment, the identity manager is configured to forward the credentials to an authorization entity. The identity manager is also configured to authorize access to the network slice based on an authorization acceptance response from the authorization entity generated by matching the credentials with authorization credentials stored at the authorization entity.

It will be appreciated that the methods and arrangements described herein can be implemented, combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Alternatively, or as a complement, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device or unit in which the proposed technology is implemented. It may also be possible to re-use existing software, e.g. by reprogramming of the existing software or by adding new software components.

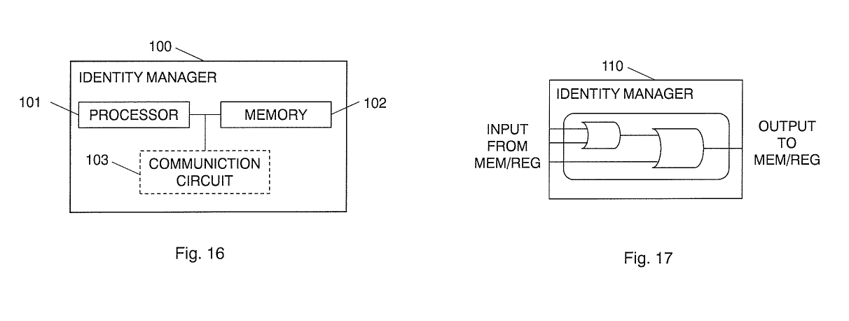

FIG. 16 is a schematic block diagram illustrating an example of an identity manager 100, based on a processor-memory implementation according to an embodiment. In this particular example, the identity manager 100 comprises a processor 101 and a memory 102. The memory 102 comprises instructions executable by the processor 101, wherein the processor 101 is operative to authenticate the user device and/or user. The processor 101 is also operative to authorize access to the network slice. The processor 101 is further operative to provide the information of the entry point for transmission to the user device.

Optionally, the identity manager 100 may also include a communication circuit 103. The communication circuit 103 may include functions for wired and/or wireless communication with user devices and/or network nodes in the network. In a particular example, the communication circuit 103 may be based on radio circuitry for communication with one or more network nodes, including transmitting and/or receiving information. The communication circuit 103 may be interconnected to the processor 101 and/or memory 102. By way of example, the communication circuit 103 may include any of the following: a receiver, a transmitter, a transceiver, input/output (I/O) circuitry, input port(s) and/or output port(s).

FIG. 17 is a schematic block diagram illustrating another example of an identity manager 110, based on a hardware circuitry implementation according to an embodiment. Particular examples of suitable hardware circuitry include one or more suitably configured or possibly reconfigurable electronic circuitry, e.g. Application Specific Integrated Circuits (ASICs), FPGAs, or any other hardware logic such as circuits based on discrete logic gates and/or flip-flops interconnected to perform specialized functions in connection with suitable registers (REG), and/or memory units (MEM).

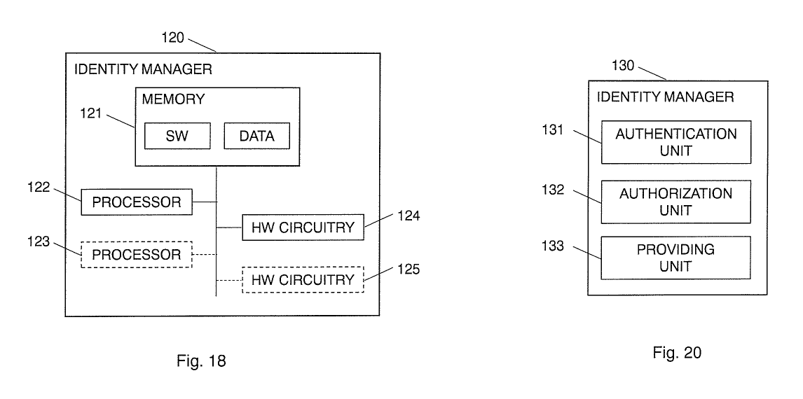

FIG. 18 is a schematic block diagram illustrating yet another example of an identity manager 120, based on combination of both processor(s) 122, 123 and hardware circuitry 124, 125 in connection with suitable memory unit(s) 121. The identity manager 120 comprises one or more processors 122, 123, memory 121 including storage for software (SW) and data, and one or more units of hardware circuitry 124, 125, such as ASICs and/or FPGAs. The overall functionality is thus partitioned between programmed software for execution on one or more processors 122, 123, and one or more pre-configured or possibly reconfigurable hardware circuits 124, 125, such as ASICs and/or FPGAs. The actual hardware-software partitioning can be decided by a system designer based on a number of factors including processing speed, cost of implementation and other requirements.

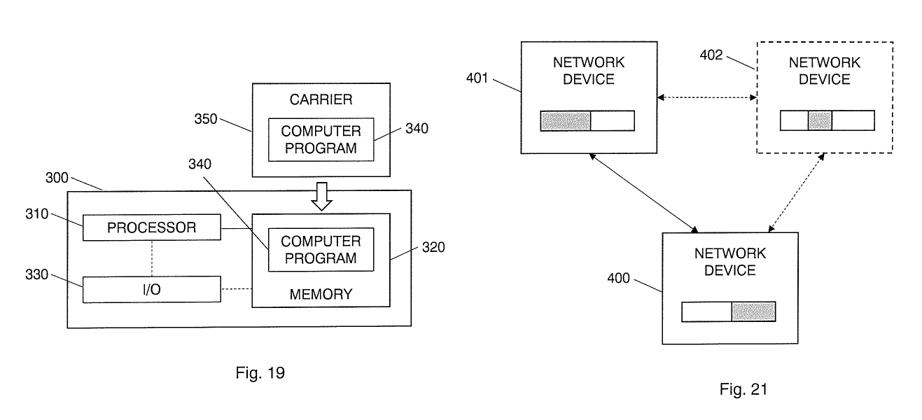

FIG. 19 is a schematic diagram illustrating an example of a computer-implementation of an identity manager 300 according to an embodiment. In this particular example, at least some of the steps, functions, procedures, modules and/or blocks described herein are implemented in a computer program 340, which is loaded into the memory 320 for execution by processing circuitry including one or more processors 310. The processor(s) 310 and memory 320 are interconnected to each other to enable normal software execution. An optional input/output (I/O) device 330 may also be interconnected to the processor(s) 310 and/or the memory 320 to enable input and/or output of relevant data, such as input of request messages and output of messages of authorization and application entry points.

The term ‘processor’ should be interpreted in a general sense as any system or device capable of executing program code or computer program instructions to perform a particular processing, determining or computing task.

The processing circuitry including one or more processors 310 is thus configured to perform, when executing the computer program 340, well-defined processing tasks such as those described herein.

The processing circuitry does not have to be dedicated to only execute the above-described steps, functions, procedure and/or blocks, but may also execute other tasks.

In a particular embodiment, the computer program 340 comprises instructions, which when executed by at least one processor 310, cause the at least one processor 310 to authenticate a user device and/or a user of the user device to correlate the user device and/or the user to a network slice type of a network operator providing multiple network slices having a respective network slice type. The at least one processor 310 is also caused to authorize access to a network slice of the network slice type among the multiple network slices based on credentials of the user device and/or the user. The at least one processor 310 is further caused to provide, for transmission to the user device, information of an entry point to an application provided by the network slice.

The proposed technology also provides a carrier 350 comprising the computer program 340, wherein the carrier 350 is one of an electronic signal, an optical signal, an electromagnetic signal, a magnetic signal, an electric signal, a radio signal, a microwave signal, or a computer-readable storage medium.

By way of example, the software or computer program 340 may be realized as a computer program product 350, which is normally carried or stored on a computer-readable medium, in particular a non-volatile medium. Thus, the proposed technology further provides a computer-program product 350 comprising a computer-readable medium having stored thereon a computer program 340 as defined above.

The computer-readable medium may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program 340 may thus be loaded into the operating memory of a computer or equivalent processing device for execution by the processing circuitry 310 thereof.

The flow diagram or diagrams presented herein may be regarded as a computer flow diagram or diagrams, when performed by one or more processors. A corresponding identity manager may be defined as a group of function modules, where each step performed by the processor corresponds to a function module. In this case, the function modules are implemented as a computer program running on the processor.

The computer program residing in memory may thus be organized as appropriate function modules configured to perform, when executed by the processor, at least part of the steps and/or tasks described herein.

FIG. 20 is a schematic diagram illustrating an example of an identity manager 130. The identity manager 130 comprises an authentication unit 131 for authenticating a user device and/or a user of the user device based on a network attachment request originating from the user device to correlate the user device and/or the user to a network slice type of a network operator providing multiple network slices having a respective network slice type. The identity manager 130 also comprises an authorization unit 132 for authorizing access to a network slice of the network slice type among the multiple network slices based on credentials of the user device and/or the user. The identity manager 130 further comprises a providing unit 133 for providing, for transmission to the user device, information of an entry point to an application provided by the network slice.

Alternatively it is possible to realize the modules in FIG. 20 predominantly by hardware modules, or alternatively by hardware, with suitable interconnections between relevant modules. Particular examples include one or more suitably configured digital signal processors and other known electronic circuits, e.g. discrete logic gates interconnected to perform a specialized function, and/or ASICs as previously mentioned. Other examples of usable hardware include I/O circuitry and/or circuitry for receiving and/or sending signals. The extent of software versus hardware is purely implementation selection.

It is becoming increasingly popular to provide computing services in network devices, such as network nodes and/or servers, where the resources are delivered as a service to remote locations over a network. By way of example, this means that functionality, as described herein, can be distributed or re-located to one or more separate physical nodes or servers. The functionality may be re-located or distributed to one or more jointly acting physical and/or virtual machines that can be positioned in separate physical node(s), i.e. in the so-called cloud. This is sometimes also referred to as cloud computing, which is a model for enabling ubiquitous on-demand network access to a pool of configurable computing resources such as networks, servers, storage, applications and general or customized services.

FIG. 21 is a schematic diagram illustrating an example of how functionality can be distributed or partitioned between different network devices 400, 401 in a general case. In this example, there are at least two individual, but interconnected network devices 400, 401, which may have different functionalities, or parts of the same functionality, partitioned between the network devices 400, 401. There may be additional network devices 402 being part of such a distributed implementation. The network devices 400, 401, 402 may be part of the same wireless communication system, or one or more of the network devices may be so-called cloud-based network devices located outside of the wireless communication system.

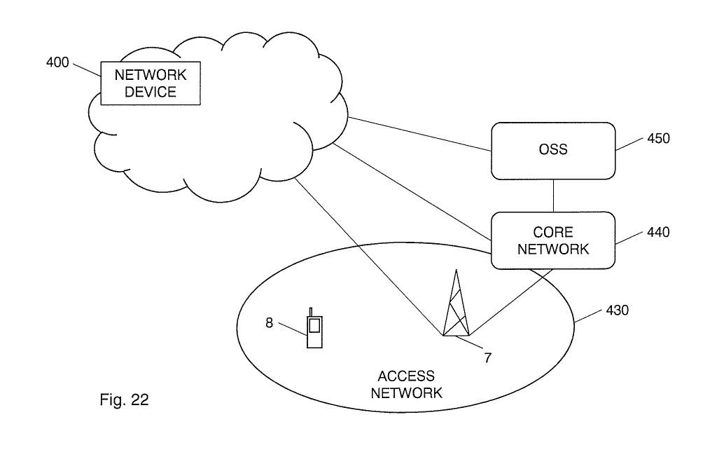

FIG. 22 is a schematic diagram illustrating an example of a wireless communication system, including an access network 430 and/or a core network 440 and/or an Operations and Support System (OSS) 450 in cooperation with one or more cloud-based network devices 400. Functionality relevant for the access network 430 and/or the core network 440 and/or the OSS system 450 may be at least partially implemented for execution in a cloud-based network device 400, with suitable transfer of information between the cloud-based network device and the relevant network nodes and/or communication units in the access network and/or the core network and/or the OSS system. The figure also illustrates a network node 7, represented by an eNB in the figure, and a user device 8.

A network device 400 may generally be seen as an electronic device being communicatively connected to other electronic devices in the network. By way of example, the network device 400 may be implemented in hardware, software or a combination thereof. For example, the network device 400 may be a special-purpose network device or a general purpose network device, or a hybrid thereof.

A special-purpose network device may use custom processing circuits and a proprietary operating system (OS), for execution of software to provide one or more of the features or functions disclosed herein. A general purpose network device may use common off-the-shelf (COTS) processors and a standard OS, for execution of software configured to provide one or more of the features or functions disclosed herein. By way of example, a special-purpose network device may include hardware comprising processing or computing resource(s), which typically include a set of one or more processors, and physical network interfaces (NIs), which sometimes are called physical ports, as well as non-transitory machine readable storage media having stored thereon software. A physical NI may be seen as hardware in a network device through which a network connection is made, e.g. wirelessly through a wireless network interface controller (WNIC) or through plugging in a cable to a physical port connected to a network interface controller (NIC). During operation, the software may be executed by the hardware to instantiate a set of one or more software instance(s). Each of the software instance(s), and that part of the hardware that executes that software instance, may form a separate virtual network element.

By way of another example, a general purpose network device may for example include hardware comprising a set of one or more processor(s), often COTS processors, and network interface controller(s) (NICs), as well as non-transitory machine readable storage media having stored thereon software. During operation, the processor(s) executes the software to instantiate one or more sets of one or more applications. While one embodiment does not implement virtualization, alternative embodiments may use different forms of virtualization—for example represented by a virtualization layer and software containers. For example, one such alternative embodiment implements operating system-level virtualization, in which case the virtualization layer represents the kernel of an operating system or a shim executing on a base operating system that allows for the creation of multiple software containers that may each be used to execute one of a sets of applications. In an example embodiment, each of the software containers, also called virtualization engines, virtual private servers, or jails, is a user space instance, typically a virtual memory space. These user space instances may be separate from each other and separate from the kernel space in which the operating system is executed; the set of applications running in a given user space, unless explicitly allowed, cannot access the memory of the other processes. Another such alternative embodiment implements full virtualization, in which case: 1) the virtualization layer represents a hypervisor, sometimes referred to as a Virtual Machine Monitor (VMM), or the hypervisor is executed on top of a host operating system; and 2) the software containers each represent a tightly isolated form of software container called a virtual machine that is executed by the hypervisor and may include a guest operating system.

A hypervisor is the software/hardware that is responsible for creating and managing the various virtualized instances and in some cases the actual physical hardware. The hypervisor manages the underlying resources and presents them as virtualized instances. What the hypervisor virtualizes to appear as a single processor may actually comprise multiple separate processors. From the perspective of the operating system, the virtualized instances appear to be actual hardware components.

A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications as well as the virtualization layer and software containers if implemented, are collectively referred to as software instance(s). Each set of applications, corresponding software container if implemented, and that part of the hardware that executes them (be it hardware dedicated to that execution and/or time slices of hardware temporally shared by software containers), forms a separate virtual network element(s).

The virtual network element(s) may perform similar functionality compared to Virtual Network Element(s) (VNEs). This virtualization of the hardware is sometimes referred to as Network Function Virtualization (NFV)). Thus, NFV may be used to consolidate many network equipment types onto industry standard high volume server hardware, physical switches, and physical storage, which could be located in data centers, NDs, and Customer Premise Equipment (CPE). However, different embodiments may implement one or more of the software container(s) differently. For example, while embodiments are illustrated with each software container corresponding to a VNE, alternative embodiments may implement this correspondence or mapping between software container-VNE at a finer granularity level; it should be understood that the techniques described herein with reference to a correspondence of software containers to VNEs also apply to embodiments where such a finer level of granularity is used.

According to yet another embodiment, there is provided a hybrid network device, which includes both custom processing circuitry/proprietary OS and COTS processors/standard OS in a network device, e.g. in a card or circuit board within a network device ND. In certain embodiments of such a hybrid network device, a platform Virtual Machine (VM), such as a VM that implements functionality of a special-purpose network device, could provide for para-virtualization to the hardware present in the hybrid network device.

The identity manager of the embodiments can be implemented in a network node 7. The network node 7 may form part of the access network 430, the core network 440 or the OSS 450. Alternatively, the identity manager can be implemented in one or more, i.e. distributed implementation, network devices 400.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A network slice selection method, said method comprising:
authenticating, by an identity manager of a network operator providing multiple network slices having a respective network slice type, a user device and/or a user of said user device based on a network attachment request originating from said user device to correlate said user device and/or said user to a network slice type;
authorizing by said identity manager, access to a network slice of said network slice type among said multiple network slices based on credentials of said user device and/or said user; and
providing, by said identify manager and for transmission to said user device, information of an entry point to an application provided by said network slice.

2. The method of claim 1, further comprising registering said identity manager as an attachment entry point for said multiple network slices of said network operator at a database of registered network slices.

3. The method of claim 1, further comprising selecting, by said identity manager, an authentication method among multiple authentication methods based on identity information retrieved from said network attachment request, wherein authenticating said user device and/or said user comprises authenticating, by said identity manager, said user device and/or said user based on said network attachment request and according to said selected authentication method.

4. The method of claim 1, wherein authenticating said user device and/or said user comprises:
authenticating, by said identity manager, an identity of said user device and/or said user based on said network attachment request;
providing, by said identity manager, a user device profile of said user device and/or a user profile of said user based on said authenticated identity of said user device and/or said user; and
correlating, by said identity manager, said user device and/or said user to said network slice type by matching capabilities of said user device with respective requirements for said network slice types based on said user device profile and/or matching a subscription of said user with said network slice types based on said user profile.

5. The method of claim 4, further comprising selecting, by said identity manager, a user profile among multiple user profiles of said user based on profile information originating from said user device.

6. The method of claim 1, further comprising providing, by said identity manager, information of an authorization entry point at said identity manager for transmission to said user device following authentication of said user device and/or said user.

7. The method of claim 6, wherein authorizing access comprises authorizing, by said identity manager, access to said network slice based on said credentials received by said identity manager at said authorization entry point and originating from said user device.

8. The method of claim 1, wherein authorizing access comprises authorizing, by said identity manager, access to said network slice based on said credentials retrieved by said identity manager from said network attachment request.

9. The method of claim 1, further comprising selecting, by said identity manager, a service profile of said user based on profile information originating from said user device, wherein authorizing access comprises authorizing, by said identity manager, access to said network slice based on said credentials and said service profile.

10. The method of claim 1, wherein authorizing access comprises:
forwarding, by said identity manager, said credentials to an authorization entity; and
authorizing, by said identity manager, access to said network slice based on an authorization acceptance response from said authorization entity generated by matching said credentials with authorization credentials stored at said authorization entity.

11. An identity manager, wherein
said identity manager is configured to authenticate a user device and/or a user of said user device based on a network attachment request originating from said user device to correlate said user device and/or said user to a network slice type of a network operator providing multiple network slices having a respective network slice type;
said identity manager is configured to authorize access to a network slice of said network slice type among said multiple network slices based on credentials of said user device and/or said user; and
said identity manager is configured to provide, for transmission to said user device, information of an entry point to an application provided by said network slice.

12. The identity of claim 11, wherein said identity manager is configured to register said identity manager as an attachment entry point for said multiple network slices of said network operator at a database of registered network slices.

13. The identity manager of claim 11, wherein
said identity manager is configured to select an authentication method among multiple authentication methods based on identity information retrieved from said network attachment request; and
said identity manager is configured to authenticate said user device and/or said user based on said network attachment request and according to said selected authentication method.

14. The identity manager of claim 11, wherein
said identity manager is configured to authenticate an identity of said user device and/or said user based on said network attachment request;
said identity manager is configured to provide a user device profile of said user device and/or a user profile of said user based on said authenticated identity of said user device and/or said user; and
said identity manager is configured to correlate said user device and/or said user to said network slice type by matching capabilities of said user device with respective requirements for said network slice types based on said user device profile and/or matching a subscription of said user with said network slice types based on said user profile.

15. The identity manager of claim 14, wherein said identity manager is configured to select a user profile among multiple user profiles of said user based on profile information originating from said user device.

16. The identity manager of claim 11, wherein said identity manager is configured to provide information of an authorization entry point at said identity manager for transmission to said user device following authentication of said user device and/or said user.

17. The identity manager of claim 16, wherein said identity manager is configured to authorize access to said network slice based on said credentials received by said identity manager at said authorization entry point and originating from said user device.

18. The identity manager of claim 11, wherein said identity manager is configured to authorize access to said network slice based on said credentials retrieved by said identity manager from said network attachment request.

19. The identity manager of claim 11, wherein
said identity manager is configured to select a service profile of said user based on profile information originating from said user device; and
said identity manager is configured to authorize access to said network slice based on said credentials and said service profile.

20. The identity manager of claim 11, wherein
said identity manager is configured to forward said credentials to an authorization entity; and
said identity manager is configured to authorize access to said network slice based on an authorization acceptance response from said authorization entity generated by matching said credentials with authorization credentials stored at said authorization entity.

21. The identity manager of claim 11, comprising
a processor; and
a memory comprising instructions executable by said processor, wherein
said processor is operative to authenticate said user device and/or said user
said processor is operative to authorize access to said network slice; and
said processor is operative to provide said information of said entry point.

22. An identity manager comprising:
an authentication unit for authenticating a user device and/or a user of said user device based on a network attachment request originating from said user device to correlate said user device and/or said user to a network slice type of a network operator providing multiple network slices having a respective network slice type;
an authorization unit for authorizing access to a network slice of said network slice type among said multiple network slices based on credentials of said user device and/or said user; and
a providing unit for providing, for transmission to said user device, information of an entry point to an application provided by said network slice.

23. A network node comprising an identity manager of claim 11.

24. A computer program product comprising a non-transitory computer readable medium storing a computer program comprising instructions, which when executed by at least one processor, cause said at least one processor to
authenticate a user device and/or a user of said user device based on a network attachment request originating from said user device to correlate said user device and/or said user to a network slice type of a network operator providing multiple network slices having a respective network slice type;
authorize access to a network slice of said network slice type among said multiple network slices based on credentials of said user device and/or said user; and
provide, for transmission to said user device, information of an entry point to an application provided by said network slice.

25-26. (canceled)
